(19) United States
(12) Patent Application Publication
(10) Pub. No.: US 2007/0011158 A1
(43) Pub. Date: Jan. 11, 2007

(54) Personal information database with context-driven information retrieval

(76) Inventor: Prashant Shashikant Parikh, Naperville, CA (US)

Correspondence Address: John W. Hayes, P.O. Box 365, Arlington Heights, IL, 60006-0365, US

(21) Appl. No.: 11/175,759

(22) Filed: Jul. 6, 2005

(51) Int. Cl. G06F 17/30

(52) U.S. Cl. 707/6

(57) ABSTRACT

A personal information database in which a particular field (or fields) of an individual's personal information record that a requester receives is determined by the context of the transaction. When an e-mail application accesses the database, for example, the PID (personal identification of a database subscriber) identifies the database subscriber (and hence the record ID). The fact that an e-mail application is requesting information identifies the context of the transaction (e-mail address request). Thus, only the e-mail address is provided to the requester. The same inherent selection of particular information fields by context occurs if a cellular telephone system accesses the database (mobile telephone number field), the USPS (United States Postal Service) accesses the database (postal address fields), or a web browser accesses the database (web site URL field). The present invention comprises a centralized, distributed or hierarchical personal information database, and method for use, having wide access capability. The preferred method for accessing the database is the Internet, although other methods of retrieving data, such as telephone, FAX, paper mail, VPN (virtual private network), etc., may also be utilized.

### FIELD OF THE INVENTION

This invention relates generally to a database of information and in particular to a searchable database of information relating not only to persons, but also businesses and other entities, and is more particularly directed toward a searchable information database in which the information retrieved and transmitted to a requester is, at least in part, automatically determined by the context of the request.

### BACKGROUND OF THE INVENTION

The present environment of widespread electronic accessibility of multiple sources of information has given rise to a situation in which many persons and business entities have lost positive control over both the location and accuracy of such information. In particular, this information includes personal details such as name, postal address, telephone number, e-mail address, etc. This information is needed by many, and there is currently no system in place that allows an efficient, categorized distribution of such information with safeguards in place to ensure that sensitive information is not readily transmitted to unauthorized requesters.

There is a widespread need for up-to-date personal details, and because of the many interested parties, it may be impracticable to provide proper notices of change of address, phone number, etc. to all concerned. This can be particularly difficult because of record duplication. Many organizations store redundant public information about people or organizations, for example. It is also possible that one or more organizations, such as a government agency, medical service provider, financial institution, etc. may need to contact an individual or company after a long period of inactivity.

As noted, one of the reasons for the current state of affairs is that data are often stored in more than one place, and it is impossible for the people to whom these data relate to maintain currency of all their information. This unwanted replication of data may occur, for example, because of mailing list proliferation, or the creation of multiple customer records in response to name or address changes. There have been a number of attempts to ameliorate this problem, but it is admittedly difficult to allow sharing of personal details without maintaining strict security to ensure that this personal information is not abused.

Published U.S. Patent Application No. 2003/0159068 (Halpin et al.) is directed toward an authentication protocol that works with systems in which a single security check can serve for all subscriber sites. For added security, an additional PIN number is transmitted to the user's cell phone (the system already knows the user's phone number), and is then entered by the user for further authentication. According to the specification, this system is useful for any secure site, such as those dedicated to shopping. Furthermore, this development is not limited to access to sites through which sensitive information is available.

Published U.S. Patent Application No. 2003/0177356 (Abela) discusses the establishment of a worldwide trusted identification protocol for access to personal details. The inventor envisions tacking a country identifier onto an existing unique identification sequence (such as a Social Security number) and tying together a worldwide network of databases, with each individual country acting as authentication/authorization broker.

Published U.S. Patent Application No. 2003/0009435 (Gopalan) describes a personal database that is accessible via the Internet. The data base itself includes personal information such as name, address, telephone number, etc. The originator may enter or update information by accessing the database using a basic and a primary number. Access to the data base may be granted to others as well, with the data fields available being defined by the primary number in combination with a secondary number. The particular data fields accessible are defined by the secondary number.

Gopalan's database contains information records and fields of personal details, such as full name, address, telephone number, e-mail address, etc. Access to information is controlled by passwords that are constructed and distributed in a particular fashion. A potential database user can be granted access to the personal information stored in the database by knowing the proper password combinations.

U.S. Pat. No. 6,065,016 issued May 16, 2000 to Peter Stuntebeck and Andrew Bulfer, and the patent describes what the inventors call a Universal Directory Service or UDS that is accessible through a number of different communication channels, including, for example, the Internet, wireless devices, or conventional telephone. A centralized UDS server communicates with a number of directories that may include relevant information. These various directories may include a directory server maintained by the UDS provider, corporate on-line directory servers, various local databases, and white pages directories. In response to receiving identifying information for an individual, the system returns all of the communication addresses associated with that individual and stored within one or more of the directories accessible to the system. A password or personal identification number (PIN) may be provided for billing purposes. In addition to communication addresses, the system may also provide access to supplemental information about the individual, such as the company name, a logo or design associated with the company, and the particular specialty in which the company or individual is engaged.

U.S. Pat. No. 6,405,245 issued Jun. 11, 2002 to Robert Burson et al. This patent describes a method for access to aggregated information associated with a particular end user. The inventors define personal information as any information unique to a particular user that often must be obtained from multiple sources. Examples of such personal information include bank statements and investment portfolios, utility bills, credit card balances and other financial obligations, personal communications such as e-mail, faxes and voice messages, and possible generic content in which the user has an interest. This generic information could include the current weather, the weather forecast, or the current prices for selected stocks or commodities. Since the personal information described above must generally be obtained by accessing a variety of information sources, such as multiple web pages over the Internet, the inventors provide a technique through which all of this information may be aggregated into a single web page. In order to do this, a personal information management system allows the user to enter the access details, including user names, passwords and other security information, so that the personal information management system can perform all of these accesses on the user's behalf, and display all of the desired personal information through a single, easy-to-use web page.

U.S. Pat. No. 6,449,621 issued Sep. 10, 2002 to Primo Pettovello, and is directed toward a privacy data escrow system and method. This patent contemplates a system in which sensitive personal information such as health data or medical claim information can be analyzed and statistically processed without compromising the identity of the individual. The inventive system does this by assembling records of sensitive information that include a scrambled personal identifier. A separate trusted escrow agent manages a mapping of a set of scrambled personal identifiers to the associated unscrambled identifiers of the persons to whom the sensitive information pertains. Using this system, sensitive personal information can be subjected to analysis without revealing the identities of any individuals. In one embodiment of the invention, the inventor suggests that analysis of medical information might suggest that some form of intervention should be initiated. This intervention could only be accomplished through the trusted escrow agent, since that is the only way the actual identity of a person whose sensitive data is being analyzed can be identified.

Published U.S. Patent Application No. 2003/0074456 (Yeung et al.) suggests a centralized application that controls access to distributed personal information of a user. An application that is requesting information from this system does not need to know where the desired information is stored. The requesting application simply transmits its request to the centralized management system. Each user that subscribes to the system is able to maintain tight security by controlling what kinds of information would be provided to a given requester. In one embodiment of the invention, a document type definition or DTD is assigned to each requesting application and to each information-providing application. This DTD can be used to establish levels of security that protect certain elements of information and can prevent this information from being transmitted to some or all requesters.

Published U.S. Patent Application No. 2003/0084050 (Hall et al.) describes a method for retrieving a user's personal address information. In this system, a hand-held communication device may be used to initiate the transmission of information. This transmission of information could be in the form of an e-mail, a facsimile, or the transmission of a digital image. Because hand-held communication devices generally have a limited memory, it may be impracticable to store large phone books on this hand-held device.

In the system of the invention, the user of the hand-held device uses an efficient LDAP (lightweight directory access protocol) interface to access his address book, which is resident on a network accessible server. Secure access protocols are observed to prevent unauthorized access to address book information. Once the address book has been accessed, entries from the address book can be viewed by the user using the hand-held device, and e-mail addresses and facsimile numbers can be easily selected by the user of the hand-held device as destinations for his e-mail traffic, facsimiles, digital images, or other types of messages.

Published U.S. Patent Application No. 2003/0135512 (Morgan, Jr. et al.) is directed toward a data linking system and method using encoded links. A system is described that can deal with large databases of records that may have some relationship. For example, businesses that collect customer information such as customer names, addresses, and telephone numbers often find that they have duplicate records in their database. This can occur with large companies, especially those having more than one operating division, where an individual may be a customer of more than one division. Duplicate records can also be collected through the usual practice of purchasing customer lists for marketing purposes.

A unique identifying link is associated with each record in the database. The association of the links with particular data records is maintained through an external information services provider. This is both to allow processing of information records should the occasion arise, and to maintain privacy of the individuals whose identification information is being stored in the database. In an exemplary embodiment of the invention, a situation develops in which duplicate records are being maintained for a given customer. The customer moves to a new location, but only notifies one of the divisions of the company that is maintaining the information database. Because the external information services provider is able to determine which records are associated with a particular individual, the database can be kept current by retaining only the record with the correct address information, and deleting the others from the database.

None of these systems of the prior art is able to aggregate or deliver data associated with a particular entity without multiple passwords for security purposes. At least some of the systems require a trusted entity, an escrow, or an administrator to carry out searches and categorization of the data, providing information access to more organizations than is strictly necessary, and leading to even more password proliferation.

Accordingly, a need arises for a system and method that easily and efficiently directs proper information to requesting entities without compromising the information-owner's privacy. This system and method should operate without requiring burdensome password or code administration.

### SUMMARY OF THE INVENTION

These needs and others are satisfied by the personal information database of the present invention, in which a particular field (or fields) of an individual's personal information record that a requester receives is determined by context. In other words, the context of the transaction determines the information retrieved. For example, if an e-mail application accesses the database, the PID (personal identification of a database subscriber) identifies the database subscriber (and hence the record ID), and the fact that an e-mail application is asking for information identifies the context of the transaction (e-mail address request). Thus, only the e-mail address is provided to the requester. The same inherent selection of particular information fields by context occurs if a cellular telephone system accesses the database (mobile telephone number field), the USPS (United States Postal Service) accesses the database (postal address fields), or a web browser accesses the database (web site URL field).

An exemplary embodiment of the present invention comprises a centralized, distributed or hierarchical personal information database, and method for use, having wide access capability. One method for accessing the database is through the Internet, although other methods of retrieving data, such as telephone, FAX, paper mail, VPN (virtual private network), etc., may also be useful. A single PID (personal identification code or designator) provides access to the database of information, although it may be necessary to provide passcode protection in order to safeguard certain categories of information.

The database itself is a fairly large collection of personal information about an individual, at least in general, although any entity, such as a corporation, for example, could have a record (or records) in the database, including corporate address and telephone information, corporate FAX and e-mail, etc. In operation, one might use the PID as a universal method of addressing correspondence. For example, in sending an e-mail, one need only provide the PID for the individual being addressed, and the e-mail application accesses the database to obtain the e-mail address.

The same could be done for a letter sent through the U.S. Postal Service. Instead of supplying a street address, the writer simply supplies the PID, and the USPS computer accesses the database and applies the postal address to the envelope. In general, for any application in which an address of some kind is needed (postal, e-mail, FAX, phone, etc.), one could use a PID. There are many other advantages of such a system. It is easy to maintain and manage. It is easier to keep track of a person even if the person's name has changed (due to marriage or divorce), or the person has moved.

The database manager itself has a number of unique features. One of these features may be termed context control of information content. If an e-mail application, such as Outlook Express, were to access the database using a PID, the context (access by an e-mail application) would determine the information retrieved (in this case, an e-mail address). The same context-sensitive retrieval would seem to apply to USPS access (the context demands a postal address) or to a web browser accessing the database (the URL of the owner's home page would be returned).

Similarly, the sending device or application has some unique features when used in conjunction with this system. The sending device queries the database using the PID and retrieves the user preference for a given context. For example, a user A uses a FAX machine to send a paper to the PID of user B. User B has set in the database his preference for receiving FAX messages as e-mail. The FAX machine is capable of sending FAX as e-mail as an attachment (like a PDF file, for example).

This capability makes the device a PID-ready device. So, these types of devices are able to convert to the appropriate format and send the information. The default behavior could be to send this message to some PID server that sends the information in correct format, or sends it in default format (like paper mail). There is therefore an algorithm that all devices can download and/or use to be PID ready.

Of course, there are security concerns for this type of system. In some situations, it would seem prudent to require the use of a passcode so that sensitive information is available only to trusted recipients. To be more secure, the PID owner can decide not to release any information without a passcode or to provide different information depending upon the passcode received. Also, the database can be designed such that only trusted/authenticated distributors (like USPS, e-mail routers, etc.) can get this information without a passcode. A passcode would be required for all other users.

In accordance with one aspect of the present invention, a method for accessing a database of information comprises the steps of submitting an information request to the database of information, in which the information request includes an identification element, and retrieving information from the database associated with the identification element, wherein the information retrieved is determined, at least in part, by the context of the information request. Preferably, the step of submitting an information request further comprises the step of submitting message traffic that designates the message recipient solely by the identification element. The identification element may comprise a unique personal identification string (PID).

In one form of the invention, the information request includes a message element, and the step of retrieving information further comprises the steps of determining the context of the information request by determining a medium of transmission associated with the message element, and retrieving information from the database corresponding to a destination address appropriate for the medium of transmission and associated with the identification element.

In another form of the invention, the message element includes elements associated with a financial transaction, and the step of retrieving information further comprises the steps of determining the context of the information request by examining the message element for a monetary amount and examining the identification element for indicia associated with a particular type of financial transaction. Information is then retrieved from the database corresponding to an account number associated with the particular type of financial transaction and associated with the identification element. The particular type of financial transaction may comprise a credit card transaction. In any event, the identification element comprises a unique personal identification string (PID), and the PID may include a supplemental string that identifies a particular credit card.

In yet another form of the invention, the method further comprises the steps of determining whether the information retrieved is subject to restricted access, and, if so, determining whether an acceptable security code has been transmitted. The message traffic is then forwarded to the intended recipient.

In accordance with another aspect of the present invention, a system for accessing a database of information comprises means for submitting an information request to the database of information, the information request including message traffic that designates the message recipient solely by an included identification element, means for determining the context of the information request by determining a medium of transmission associated with the message element, and means for retrieving information from the database corresponding to a destination address appropriate for the medium of transmission and associated with the identification element.

Further objects, features, and advantages of the present invention will become apparent from the following description and drawings.

### BRIEF DESCRIPTION OF THE DRAWINGS

FIG. 1 illustrates a system in accordance with the present invention in block diagram form;

FIG. 2 depicts, in block diagram form, retrieval of contact information by medium through a distribution system;

FIG. 3 is a Venn diagram indicating categories of information stored in a database; and

FIG. 4 is a representation of contact information being accessed through a database by means of a PID.

### DETAILED DESCRIPTION OF THE INVENTION

There is described herein a personal information database with context-driven information retrieval that offers distinct advantages when compared to the prior art.

The universal Personal Identification (PID) as set forth herein is applicable to individuals, groups, organizations, and other entities, such as corporations. The PID functions in much the same way as a Social Security number insofar as it acts as a key to information about an individual or other entity, although a PID would preferably be distinct from a Social Security Number or Tax ID, since many people are unwilling to give out their Social Security numbers unless absolutely necessary.

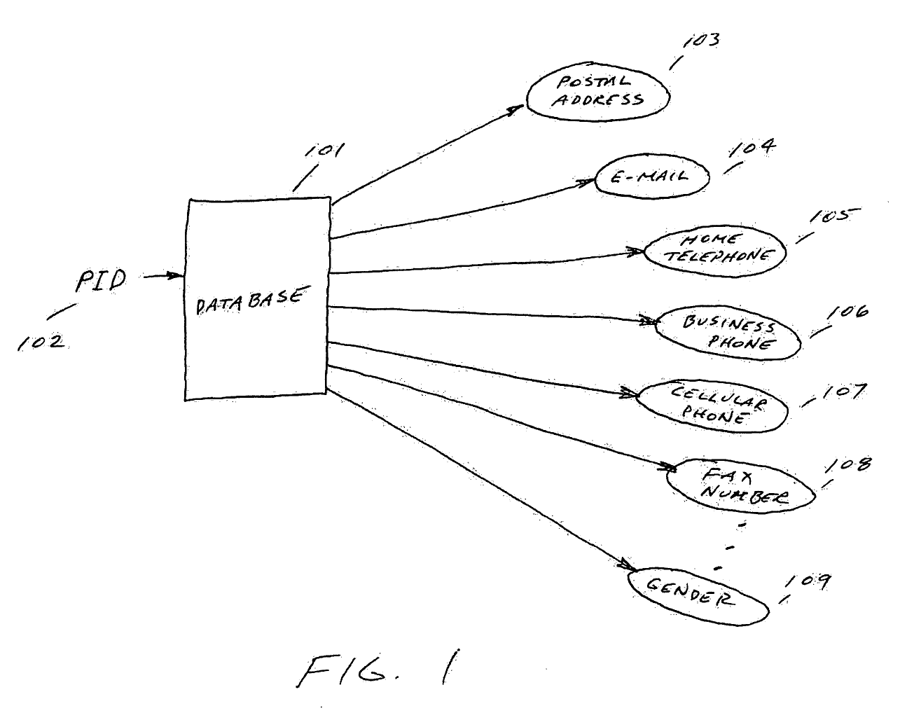

FIG. 1 illustrates, in block diagram form, a system in accordance with the present invention. By providing a unique personal identification (PID) 102, a system user is able to access a database 101 of information associated with that PID 102. The information may include, but is not by any means limited to, postal address 103, e-mail address 104, home telephone number 105, business telephone 106, cellular phone number 107, facsimile (FAX) number 108, and even categorical information such as the subscriber's gender 109.

The owner manages the information content in the system in accordance with the present invention. Information management may include collateral consultation with other information databases to ensure that all information is up-to-date. The precise information that is shared with others is under strict control of the owner of the information. In some cases, for particularly sensitive items of information, it is certainly contemplated that a passcode or similar security safeguard be employed. The system is designed to be accessible not only via the Internet or other electronic means, but also via telephone, facsimile, or even by conventional mail.

The database itself is designed for centralized and constant information input. Because the information fields of the database are mapped or linked to a particular PID, accessibility of a subscriber's information is unaffected by changes of name (such as might occur by marriage), changes of address, telephone number, etc. Appropriate, accurate contact information can always be retrieved form the database, and access to the database itself, at least insofar as unrestricted information content is concerned, is preferably universal.

As noted, some items of information may be restricted by the subscriber and not made available in response to general inquiries. In cases like this, a passcode must be provided by the requester in order to enable access to this restricted information. However, most subscribers would prefer that contact information in the form of address, telephone number, e-mail address, etc., be accessible to all requesters without the need for entering a particular security code. Since multiple contact addresses are stored within the database, the system may be used to send any information to the subscriber identified by his PID. Ideally, anyone who knows the subscriber's PID should be able to send e-mail messages, conventional mail, telephone calls, FAXes, etc.

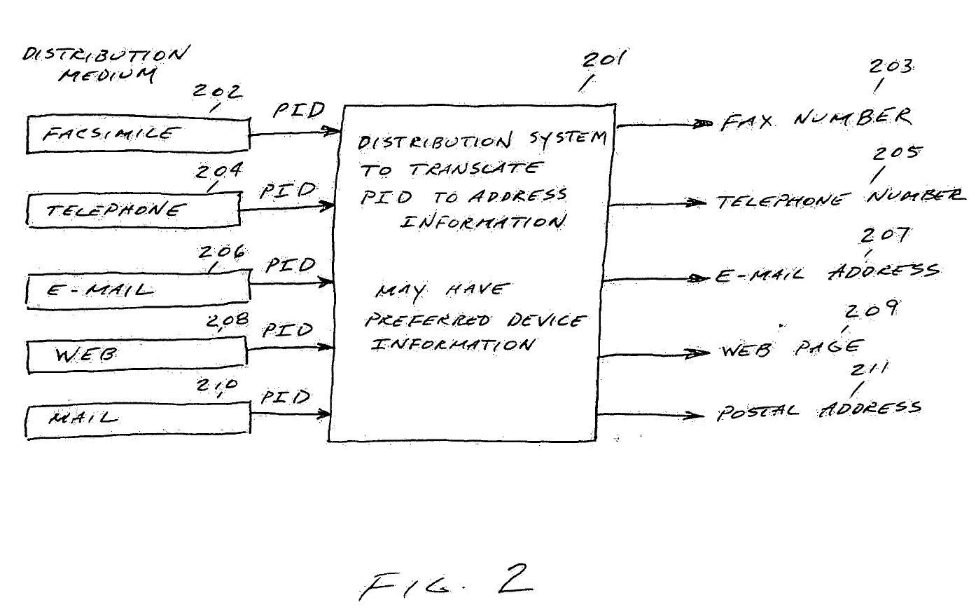

In fact, as illustrated in FIG. 2, a system user merely supplies the PID of the intended recipient, along with the message traffic, to compel the system to extract the appropriate contact address for the selected medium of transmission. For a facsimile message 202, the sender need only provide the PID to the distribution system 201 along with the text of his FAX message, and the system 201 automatically extracts the FAX number 203 based upon the context of the request: in this case, a FAX transmission 202. Similarly, the system 201 will extract a telephone number 205 after determining that the context of the information request is a telephone call 204. The telephone message 204 could be a digitized voice message for forwarding, or simply a request from a telephone dialer. As long as the system 201 understands the context of the request the correct information will be retrieved.

Perhaps the most common type of request anticipated for the system 201 to handle is the submission of e-mail traffic 206. In response to the submission of e-mail message traffic in conjunction with the intended recipient's PID, the system 201 will retrieve the e-mail address 207 of the individual, group, or other entity designated by the PID. If the message traffic 208 is destined for the web, the system will retrieve the URL (Uniform Resource Locator) or IP (Internet Protocol) address 209 associated with the PID. The same, of course, is true for conventional mail messages 210. When the system user submits a mail message 210 along with the PID, the system 201 retrieves the postal address 211 based upon the context (conventional mail) of the request. The feature could be used to print labels for mass mailings, for example, just as easily as it can be employed for a single mailing.

The system in accordance with the present invention may also be used to simplify telephone access. Rather than having to carry an address book with a myriad of contact details for a large number of persons, an individual would simply need to know the PIDs for his or her frequent contacts. By dialing an access number (or perhaps just a prefix string) the user would key in the called party's PID through the telephone keypad. The exchange is then connected to the PID service/database, which translates to the telephone number of the called party and completes the call. The PID designates the number to translate.

There are a number of ways in which the system in accordance with the present invention may be integrated with the conventional address book. First, one may periodically download updates from the system (pidserver, it may be termed), with no context sensitivity. Or, for e-mail messages, one could simply address messages as PID@pidserver.com and have the system extract the proper destination address. Of course, if the subscriber regards his e-mail address as sensitive information, it may be necessary to supply a passcode. This could be done in the following format: PIDpassword@pidserver.com. Of course, as noted previously, a separate PID field may be created (with an accommodation for a passcode, if necessary), and this format may be used for e-mail. Address book interface with a general purpose e-mail system is the same.

For e-mail delivery with a PID, the MIME type is set to e-mail, and the e-mail message is sent to the pidserver (the database front end). For normal processing, the pidserver queries for the destination and preference for MIME type (including a password check should the destination require it). If the passcode does not match, send FAIL. If the destination MIME type is e-mail, change the e-mail address and forward. If the destination MIME type is other than e-mail, convert to appropriate MIME type (FAX, paper copy, etc.) and use destination address that corresponds to MIME type. Of course, the passcode requirement is one way of preventing spam and junk mail.

For telephone call delivery for the system in accordance with the present invention, if IP call that is capable of taking ASCII characters as a phone number, use PID (and optional passcode, if necessary, to create a string). The softswitch that processes the incoming request will be able to query the pidserver to get the real phone number (assuming MIME type matches). If the MIME type does not match, the pidserver will perform the conversion (complex conversion)

For FAX to FAX or FAX to email in a system in accordance with the present invention, if the FAX processor is PID-ready, it will take the PID as input and query the pidserver for the FAX address and MIME type. If MIME type matches, get the destination address and send it. If MIME type is e-mail, the pidserver will receive the FAX and convert it to text (such as a pdf file or a word processor document) and e-mail to the destination.

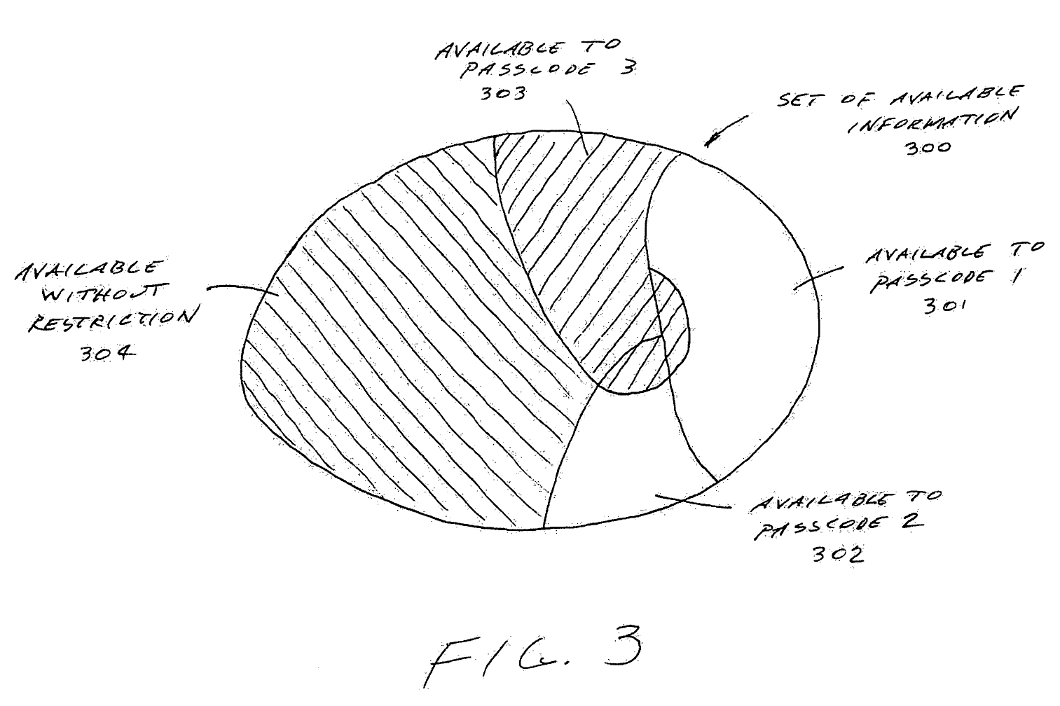

FIG. 3 is a Venn diagram indicating categories of information stored in a database, which may be considered a set of all available information 300 for a given subscriber. As noted, some subscribers will wish to designate some information 304, such as contact details, for example, as available without restriction to any requestor. But there are certain categories of information for which subscribers may wish to restrict access. Information subset 301 may be designated as being available only to requestors with passcode 1, while subset 302 may be designated for availability only to requesters with passcode 2. Of course, there may be some overlap in sensitive information, such as that illustrated in conjunction with subset 303, which may be provided to requestors with passcode 3. The information in subset 303 includes at least some information from subsets 301 and 302, as shown.

In one embodiment of the system, the receiving entity may determine the specific medium to use for receiving information. This is a situation in which the context determines the information retrieved from among the generally available information items within the database. For example, if a requester wishes to send an e-mail message and simply uses the subscriber's PID in the TO field of the e-mail, when the PID is passed to the database in an information request, the e-mail address of the subscriber is attached to the e-mail. No other information is required for this transaction, so no other information is transferred.

There are a number of ways in which this “request context” can be established. In one embodiment, the database front end is the addressee of the e-mail, with the PID of the user in the SUBJECT field. When the database front end receives the e-mail, the system is inherently informed of the e-mail “context” of the contact information request, so only the e-mail address is provided. In another embodiment, the sender delivers his message in a predefined format to the database front end, or with a flag or signal that identifies the desired medium. In either case, the system recognizes the desired medium of transmission and only the necessary contact information is extracted from the database with no need for any identifier but the PID of the intended recipient.

In many ways, the system of the present invention may be administered in much the same way in which domain names are administered today. It is essential that PIDs be unique, and each PID must be mapped to the correct individual or group so that the proper information may be retrieved.

In operation, the system does not generally require real-time immediacy. Batch processing can be used both for updating subscriber information within the database and for servicing requestor's queries for information. Senders of information would always use the PID of the intended recipient, and the system itself (or a distributor of information trusted by the system) finds the actual contact information by querying the centralized database of personal information. Ideally, information about an individual or other entity is accessed only by PID, and, if the information is sensitive such that access is restricted by the subscriber, then by providing the appropriate passcode for security purposes.

Under the system in accordance with the present invention, since contact information is retrieved from a centralized database in response to a unique PID, it is relatively easy for a user to restrict communication from pre-defined sources. This allows “Do Not Call” lists to be enacted with ease, and the same simplicity of implementation applies to other potential communication restrictions such as “Do Not FAX” lists and “Do Not Spam” lists. However, due to the same ease of access, government and medical agencies could be given the ability to contact an individual regardless of the subscriber's preferences.

A particular distribution system can easily be rendered compliant with the PID concept. The system must first be enabled to receive PIDs, and outgoing information, in the form of e-mails, FAXes, postal correspondence, etc. must be addressed using PIDs. For distribution systems where the same PIDs are used repetitively, contact information retrieved using the PID may be cached for high-speed performance. Of course, a system must be established for periodic verification in the case of remote caching.

One of the proposed features of the PID-associated database is the capability of the system to store and retrieve a preferred communication method for each subscriber. A simple query to the system could determine, for example, that the subscriber prefers e-mail communication and the particular communication in progress could be altered accordingly. Either the sender can perform the alteration (converting a paper letter to an e-mail or file attachment, for example), or the distribution system can be designed to perform this conversion autonomously. In any event, in an exemplary system in accordance with the present invention, the PID is relied upon, in general, as the sole means with which to address the destination. Of course, there may be some intended recipients who do not subscribe to the PID system, and alternative communication methodologies can be designated for such persons or entities.

In another embodiment in accordance with the present invention, a particular PID may be associated with a group of contact addresses or multiple recipients. This simplifies the broadcast e-mail concept, and also allows FAXes or other correspondence to be directed to multiple recipients through the use of a single identifier (PID). The ideal distribution system would be able to support all modes of transport for communication, or may be able to act as an alias for other distribution systems. Naturally, the preferred input means for messages directed through such a system is electronic, although scanning capability would provide the means for converting non-electronic messages into the preferred electronic format. Of course, for situations in which paper transactions are necessary, the system is able to retrieve postal address information in response to a PID and affix the postal address to documents, envelopes, and labels, as the situation may warrant.

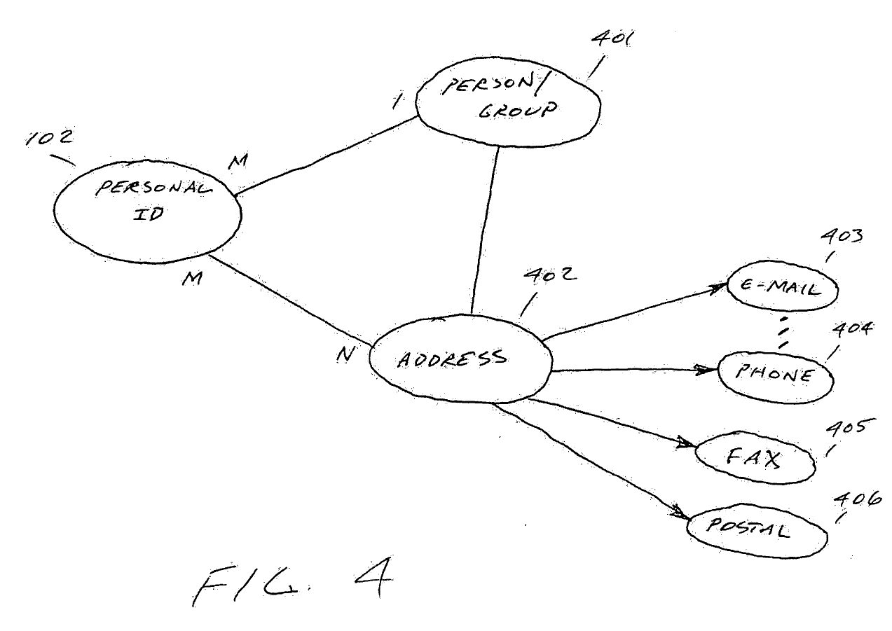

FIG. 4 is a representation of contact information being accessed through a database by means of a PID 102. In particular, provision of the PID 102 can be viewed as a mapping that associates a unique person or entity (or group of people or entities) 401 with the PID 102. As a result, one or more address information blocks 402 may be retrieved. Single or multiple contact addresses, including, but not limited to e-mail 403, telephone number 404, facsimile number 405, and postal address 406 may be linked to a particular PID 102.

In implementation, a centralized database is created to store, update, and maintain the subscribers' information. Preferably, the database can be accessed by conventional paper mail, through the Web (preferred), by telephone, FAX, or other communications media (PDA, or portable digital assistant, for example). For redundancy, and to ensure adequate throughput from a variety of locations, mirror sites should be provided. A batch mode access would improve performance for high-volume users, such as the postal service, express courier services, directory companies, etc. Naturally, the system should support multiple languages to enhance its universal appeal and utility, both for contact information and other items of personal information stored in the database.

The database can be used to hold a variety of information about a subscribing individual or entity. These items of information may include, but are not limited to: the subscriber's PID, first name, last name, middle name and/or initial, other names (such as literary pseudonyms or prior names), nicknames, street address, city or town, state, ZIP code, home telephone number, home facsimile number, cellular phone number, office telephone number, office facsimile, e-mail addresses or URLs, and important dates (such as date of birth, marriage, death, etc.).

In addition to providing a highly efficient engine for messaging distribution, a personal information database in accordance with the present invention may also be used to implement a credit card system that is much simpler and more efficient than those presently known. Using the present system, a single credit card may replace all credit cards that a subscriber may require, including retail store cards, charge cards, credit cards, debit cards, etc. Each system subscriber need only carry a single card with a unique number. This number may be derived from the subscriber's PID, and may include a routing number plus an additional random number to distinguish the credit card feature from ordinary PID information access protocols.

Naturally, this kind of implementation eliminates the need for a subscriber to carry multiple credit cards. A default bank may be added to the database for some kinds of credit cards for which an associated financial institution is required. For additional security, a photo ID may be added. The digital image associated with this photo ID may be an additional information item for storage in the database, and for retrieval by a merchant who is asked to accept a subscriber's credit card. This same card could be used for non-financial transactions, as well, such as a library card, etc.

In processing credit card transactions using the system in accordance with the present invention, the card type must be designated, then the subscriber's card is scanned (or the number entered) in much the same way in which card information is currently input. However, the card number (which is based on the PID) is sent to the system in accordance with the present invention so that account and transaction details may be forwarded to the credit card company for processing. In the alternative, of course, it may be best to forward the card number/PID directly to the credit card transaction clearing house. The clearing house can then access the database and forward account particulars to the proper destination. The remainder of the transaction would proceed in the same fashion in which credit card transactions are currently processed.

There has been described herein a personal information database with context-driven information retrieval that offers distinct advantages when compared with the prior art. It will be apparent to those skilled in the art that modifications may be made without departing from the spirit and scope of the invention. Accordingly, it is not intended that the invention be limited except as may be necessary in view of the appended claims.

What is claimed is:

1. A method for accessing a database of information, the method comprising the steps of:
(a) submitting an information request to the database of information, the information request including an identification element; and
(b) retrieving information from the database associated with the identification element, wherein the information retrieved is determined, at least in part, by the context of the information request.

2. The method in accordance with claim 1, wherein the step (a) of submitting an information request further comprises the step of submitting message traffic that designates the message recipient solely by the identification element.

3. The method in accordance with claim 1, wherein the identification element comprises a unique personal identification string (PID).

4. The method in accordance with claim 2, wherein the information request includes a message element, and the step (b) of retrieving information further comprises the steps of:
(b1) determining the context of the information request by determining a medium of transmission associated with the message element; and
(b2) retrieving information from the database corresponding to a destination address appropriate for the medium of transmission and associated with the identification element.

5. The method in accordance with claim 4, wherein the message element includes elements associated with a financial transaction, and the step (b) of retrieving information further comprises the steps of:
(b3) determining the context of the information request by examining the message element for a monetary amount and examining the identification element for indicia associated with a particular type of financial transaction; and
(b3) retrieving information from the database corresponding to an account number associated with the particular type of financial transaction and associated with the identification element.

6. The method in accordance with claim 5, wherein the particular type of financial transaction comprises a credit card transaction.

7. The method in accordance with claim 5, wherein the identification element comprises a unique personal identification string (PID).

8. The method in accordance with claim 7, wherein the PID includes a supplemental string that identifies a particular credit card.

9. The method in accordance with claim 4, further comprising the steps of:
(c) determining whether the information retrieved is subject to restricted access, and, if so;
(d) determining whether an acceptable security code has been transmitted.

10. The method in accordance with claim 9, further comprising the step of:
(e) forwarding the message traffic to the intended recipient.

11. The method in accordance with claim 10, wherein the medium of transmission is selected from the set of transmission media consisting of:
e-mail;
facsimile;
telephone;
conventional mail; and
Internet.

12. A method for accessing a database of information, the method comprising the steps of:
(a) submitting an information request to the database of information, the information request including message traffic that designates the message recipient solely by an included identification element;
(b) determining the context of the information request by determining a medium of transmission associated with the message element; and
(c) retrieving information from the database corresponding to a destination address appropriate for the medium of transmission and associated with the identification element.

13. The method in accordance with claim 12, wherein the identification element comprises a unique personal identification string (PID).

14. The method in accordance with claim 12, further comprising the steps of:
(c) determining whether the information retrieved is subject to restricted access, and, if so;
(d) determining whether an acceptable security code has been transmitted.

15. The method in accordance with claim 14, further comprising the step of:
(e) forwarding the message traffic to the intended recipient.

16. A method for accessing a database of information, the method comprising the steps of:
(a) submitting an information request to the database of information, the information request including message traffic having elements associated with a financial transaction wherein the message traffic designates the message recipient solely by an included identification element;
(b) determining the context of the information request by examining the message element for a monetary amount and examining the identification element for indicia associated with a particular type of financial transaction; and
(c) retrieving information from the database corresponding to an account number associated with the particular type of financial transaction and associated with the identification element.

17. The method in accordance with claim 16, wherein the particular type of financial transaction comprises a credit card transaction.

18. The method in accordance with claim 16, wherein the identification element comprises a unique personal identification string (PID).

19. The method in accordance with claim 18, wherein the PID includes a supplemental string that identifies a particular credit card.

20. A method for accessing a database of information, the method comprising the steps of:
(a) submitting an information request to the database of information, the information request including message traffic that designates the message recipient solely by an included identification element;
(b) determining the context of the information request by determining a medium of transmission associated with the message element;
(c) retrieving information from the database corresponding to a destination address appropriate for the medium of transmission and associated with the identification element;
(d) determining whether the information retrieved is subject to restricted access, and, if so;
(e) determining whether an acceptable security code has been transmitted; and, if the code is acceptable;
(f) forwarding the message traffic to the intended recipient.

21. A system for accessing a database of information comprising:
means for submitting an information request to the database of information, the information request including message traffic that designates the message recipient solely by an included identification element;
means for determining the context of the information request by determining a medium of transmission associated with the message element; and
means for retrieving information from the database corresponding to a destination address appropriate for the medium of transmission and associated with the identification element.

22. The system of claim 21, wherein the identification element comprises a unique personal identification string (PID).

23. The system of claim 21, further comprising:
means for determining whether the information retrieved is subject to restricted access; and
means for determining whether an acceptable security code has been transmitted.

24. The system of claim 23, further comprising:
means for forwarding the message traffic to the intended recipient.

25. A system for accessing a database of information comprising:
means for submitting an information request to the database of information, the information request including message traffic having elements associated with a financial transaction wherein the message traffic designates the message recipient solely by an included identification element;
means for determining the context of the information request by examining the message element for a monetary amount and examining the identification element for indicia associated with a particular type of financial transaction; and
means for retrieving information from the database corresponding to an account number associated with the particular type of financial transaction and associated with the identification element.

26. The system of claim 25, wherein the particular type of financial transaction comprises a credit card transaction.

27. The system of claim 25, wherein the identification element comprises a unique personal identification string (PID).

28. The system of claim 27, wherein the PID includes a supplemental string that identifies a particular credit card.
